(19) United States
(12) Patent Application Publication
(10) Pub. No.: US 2003/0156637 A1
(43) Pub. Date: Aug. 21, 2003

(54) Memory-bandwidth efficient FGS encoder

(75) Inventor: Mihaela Van Der Schaar, Ossining, NY (US)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/076,374

(22) Filed: Feb. 15, 2002

(51) Int. Cl. H04B 1/66

(52) U.S. Cl. 375/240.01

(57) ABSTRACT

A method and apparatus for fine granular scalability encoding. The following steps are repeated, for each individual transform block in an image frame. A respective plurality of residual coefficients are decomposed for the respective transform block. A respective plurality of bit-planes or discrete quantization steps are processed for the respective transform block before decomposing coefficients for a next one of the transform blocks in the image frame.

### FIELD OF THE INVENTION

The present invention relates to the implementation of a fine granular scalability (FGS) encoder.

### BACKGROUND OF THE INVENTION

Video streaming over Internet Protocol (IP) networks has enabled a wide range of multimedia applications. Internet video streaming provides real-time delivery and presentation of continuous media content while compensating for the lack of Quality-of-Service (QoS) guarantees over the Internet. Due to the variation and unpredictability of bandwidth and other performance parameters (e.g., packet loss rate) over IP networks, in general, most of the proposed streaming solutions are based on some type of a layered (or scalable) video coding scheme.

Several video scalability approaches have been adopted by video compression standards such as MPEG-2, MPEG-4, and H.263. Temporal, spatial, and quality (SNR) scalability types have been defined in these standards. All of these types of scalable video include a Base Layer (BL) and one or more Enhancement Layers (ELs). The BL part of the scalable video stream represents, in general, the minimum amount of data needed for decoding that stream. The EL part of the stream represents additional information, and therefore enhances the video signal representation when decoded by the receiver.

Fine Granular Scalability (FGS) is a new video compression framework that has been recently adopted by the MPEG-4 standard for streaming applications. FGS is capable of supporting a wide range of bandwidth-variation scenarios that characterize IP-based networks, in general, and the Internet, in particular. Images coded with this type of scalability can be decoded progressively. That is, the decoder can start decoding and displaying the image after receiving a very small amount of data. As the decoder receives more data, the quality of the decoded image is progressively enhanced until the complete information is received, decoded, and displayed. Among lead international standards, progressive image coding is one of the modes supported in JPEG and the still-image, texture coding tool in MPEG-4 video.

The EL compresses the SNR and temporal residual data using a progressive (embedded) codec. In this way, the FGS residual signal is compressed bit-plane by bit-plane, starting with the most significant bit-plane and ending with the least significant (see FIGS. 1 and 2).

FIG. 1 is a diagram showing the conventional sequence of progressive (bit-plane by bit-plane) coding from the most-significant-bit-plane (MSB) 100 to the least significant-bitplane (LSB) 102, across the entire frame. Although only a single intermediate bit-plane 101 is shown, any number of intermediate bit-planes may be coded.

FIG. 2 is a diagram showing the scanning order of the FGS enhancement-layer residual DCT coefficients. Scanning starts from the MSB 100 toward the LSB 102. In FIG. 2, only representative parts of bit-planes 100 and 101 are shown. Each 8×8 bitplane-block 200-204, 206, 210, 211, 214 is scanned using the traditional zig-zag pattern, beginning in the upper left corner, and ending in the lower right corner of the block. The term “bitplane-block” is used herein to denote a portion of the residual data within a single bit-plane corresponding to a single block.

The bitplane-blocks are scanned in groups of four (macroblocks) beginning at the upper left corner, and proceeding in clockwise fashion. The scan begins with the first bit-plane. Connecting arrows show the order; after scanning to the bottom right corner of block 200, the scan proceeds to the top left corner of block 201. From the bottom right corner of block 201, the scan proceeds to the top left corner of block 202. From the bottom right corner of block 202, the scan proceeds to the top left corner of block 203. From the bottom right corner of block 203, the scan proceeds to the next macroblock, beginning at the top left corner of block 204. After scanning for an entire first bit-plane is completed for the entire frame, scanning for the second bit-plane for the same frame begins. More generally, for each bit-plane b=1, 2, . . . m, all of the blocks k=1, 2, . . . , n are scanned for residuals in bit-plane b before beginning the first block of the next bit-plane b+1.

FIG. 3 shows a prior art FGS encoder 300 for the base and enhancement layers. FIG. 3 shows one example of a functional architecture for the base layer encoder 302 and the enhancement layer encoder 304. Although FIG. 3 shows the encoding operation based on the DCT transform, other transforms (e.g. wavelet) can also be used.

The base layer encoder 302 includes a DCT block 306, a quantization block 308 and an entropy encoder 310 that generates part of the BL stream from the original video. Further, the base encoder 302 also includes the motion estimation block 320 that produces two sets of motion vectors from the original video. one set of motion vectors corresponds to the base-layer pictures, while the other set corresponds to the temporal enhancement frames. A multiplexer (not shown) is included to multiplex the base layer motion vectors with the BL stream.

As shown in FIG. 3, the base layer encoder 302 also includes an inverse quantization block 312, an inverse DCT block 314, motion-compensation block 316 and frame-memory 318.

As shown in FIG. 3, the EL encoder 304 includes a DCT residual image block 350 for storing the residual images and MC residual images. A residual image is generated by a subtracter 351 that subtracts the output from the input of quantization block 308.

The EL encoder 304 also includes a memory 352 containing DCT coefficients of the residual images in decimal format, and a masking and scanning block 354 for masking and scanning all FGS bit-planes. An FGS entropy coding block 356 is also included to code the residual images to produce the FGS enhancement stream.

In the conventional implementation of the FGS encoder 300 (see FIG. 3), after the DCT-transform 306, the DCT-residual signal is decomposed in several bit-planes (from the msb to the Isb or to a certain pre-determined bit-plane e.g. bp_max).

Then the bit-planes are scanned bit-plane by bit-plane in block 354 and they are run-length and VLC coded in block 356. The sequential scanning of the bit-planes for an entire frame requires subsequent accesses to stored DCT coefficients in memory 352. Moreover, since the data in memory 352 are not saved in a binary (i.e. bit-plane by bit-plane) but in a decimal fashion, accessing a particular bit-plane requires not only fetching the corresponding data but also extracting the desired bit-plane using complicated masking operations.

In the conventional encoder 300, one memory 352 is necessary to store the DCT residual-coefficients. Moreover, this memory 352 is accessed repeatedly, for each bit-plane. Furthermore, in order to obtain the desired bit-plane that is to be coded, several masking operations need to be performed in block 354. Also, state information regarding the compression of previous bit-planes needs also to be stored. This process requires a considerable amount of memory accesses and computational power.

The conventional implementation of the FGS decoder 300 is thus both inefficient in terms of computation and memory accesses (i.e. bandwidth).

### SUMMARY OF THE INVENTION

The present invention is a method and apparatus for fine granular scalability encoding. The following steps are repeated, for each individual transform block in an image frame. A respective plurality of residual coefficients are decomposed for the respective transform block. A respective plurality of bit-planes or discrete quantization steps are processed for the respective transform block before decomposing coefficients for a next one of the transform blocks in the image frame.

### BRIEF DESCRIPTION OF THE DRAWINGS

FIG. 1 is a diagram showing a conventional sequence of progressive (bit-plane by bit-plane) coding from the MSB to the LSB, across an entire frame.

FIG. 2 is a diagram showing the conventional scanning order of the FGS enhancement-layer residual DCT coefficients.

FIG. 3 is a block diagram of a conventional FGS encoder.

FIG. 4 is a diagram showing the scanning order of the FGS enhancement-layer residual DCT coefficients in an exemplary encoder according to the invention.

FIG. 5 is a block diagram of an exemplary encoder according to the present invention.

FIG. 6 is a flow chart diagram showing an exemplary method of processing FGS enhancement layer residual DCT coefficients according to the present invention.

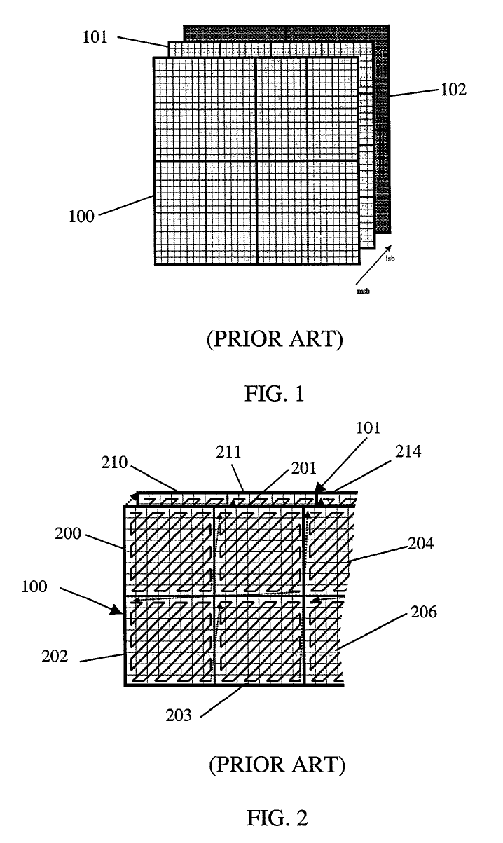

### DETAILED DESCRIPTION

In the preferred method according to the present invention, the scanning of an entire bit-plane for an entire frame is no longer performed before scanning the next less significant bit-plane for the whole frame. Instead, each block is scanned entirely (from the most-significant to the least-significant bit-plane, or from the most significant to a predetermined bit-plane) before the subsequent block within the frame is processed.

The exemplary embodiment is an alternative method for encoding the FGS frames in such a manner that memory bandwidth and computational complexity is saved.

The benefits of this new method are:

No memory is necessary for storing the all the DCT residual-coefficients for the image frame simultaneously;

The bandwidth accesses for the various bit-planes is considerably reduced (becomes almost negligible);

The masking process is performed only once per coefficient instead of many times for each bit-plane;

It is not necessary to store encoding status information of the previously coded (i.e. most-significant) bit-planes;

the encoding of FGS no longer requires a frame-delay for FGS encoding and thus the base and enhancement-layer processing can be more tightly coupled, leading to a higher efficiency in both computational complexity and memory accesses.

In order to achieve this method, the DCT residual coefficients are immediately processed for an entire DCT-block, rather then processing the bit-planes for an entire frame. Pseudocode for the general algorithm is listed below.

Algorithm.

For each DCT-block k within the image

decompose the DCT-residual coefficients in the corresponding bit-planes immediately

compute the max(|DC-coef|)=Nmax(k) for block k

For each b bit-plane<Nmax(k)

process each bit-plane, i.e. run-length and VLC code it

store each bit-plane at a different location starting at a known position (in the case this block is not the first one, append the coded bit-plane b after the already coded bit-planes b of the previous blocks

Compute N=the maximum between all Nmax(k).

Create the compressed bit-stream, by appending the various bit-planes in the order of their significance (msb to lsb).

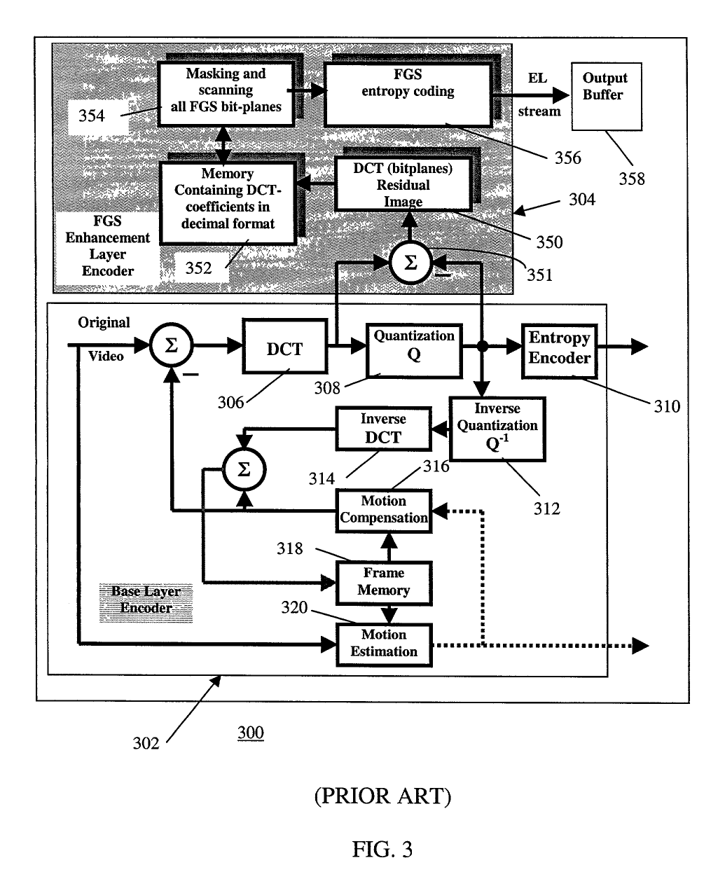

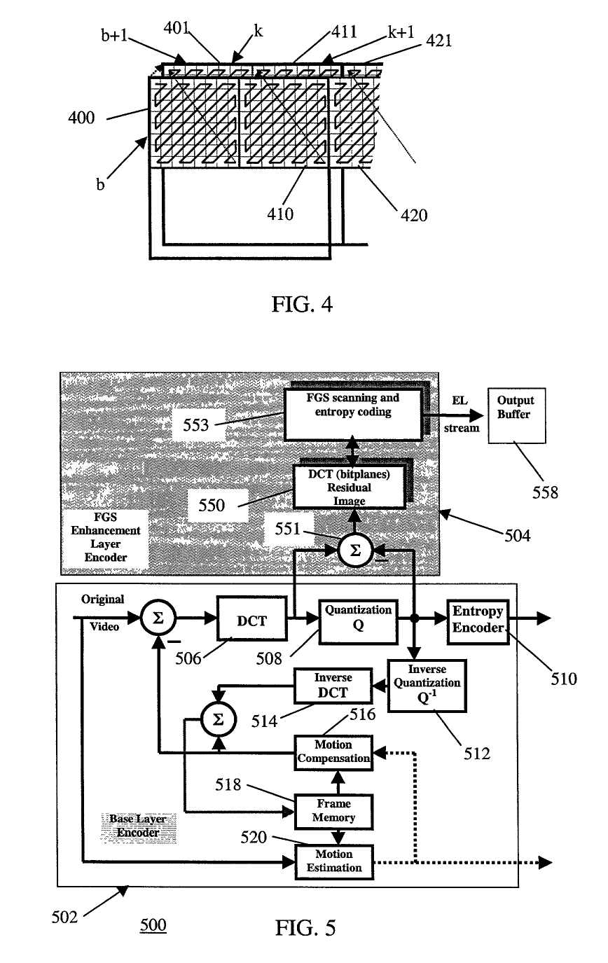

FIG. 4 shows the scanning order of the FGS enhancement-layer residual DCT coefficients for processing. The scanning order is modified from the conventional scanning order shown in FIG. 2. (However, once the scanning is completed, the transmission order is the same as the transmission order for the output signal from the conventional encoder 300 shown in FIG. 3.) More specifically, after scanning from the top left corner to the bottom right corner of bitplane-block 400 on bit-plane b, the scan proceeds to the top left corner of bitplane-block 401 on bit-plane b+1. Although only two bit-planes (b and b+1) are shown in FIG. 4, any number of bit-planes may be present. After scanning to the bottom right corner of bitplane-block 401, the scan proceeds to the top left corner of the first bitplane-block in the third bit-plane, if present. Only after the bitplane-blocks 400, 401 of the first block are scanned across every bit-plane does the scan proceed to the bitplane-block 410 of the block in the second position in the first bitplane b. More generally, for any block k, the bitplane-blocks in all of the bitplanes b=1, 2, . . . , n are scanned before scanning the first bitplane-block of block k+1.

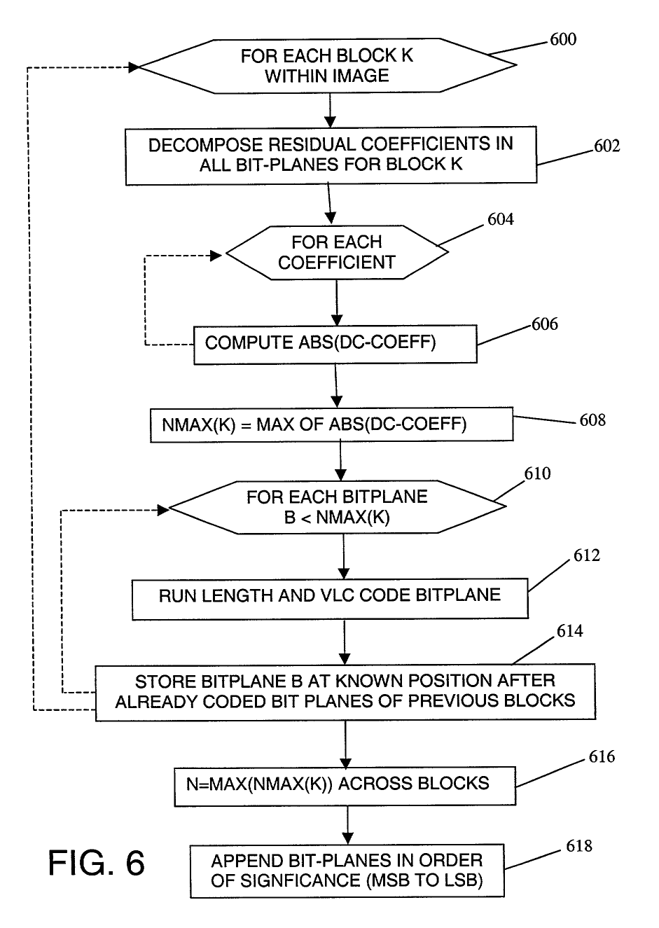

FIG. 6 is a flow chart diagram showing the algorithm.

At step 600, a loop is initiated. Steps 602-614 are repeated for each individual transform block (e.g., DCT block) k within an image frame.

At step 602, the residual DCT coefficients in all bit-planes for block k are decomposed immediately. That is, the various bitplane-blocks for block k are decomposed, one bit-plane after the other, instead of decomposing coefficients for the entire bit-plane, one block after the other.

At step 604, a loop is initiated in which step 606 is repeated for each coefficient of block k. At step 606, the absolute value of the quantity (DC-coefficient) is computed.

At step 608, NMAX(k) for block (k) is set to the maximum value of abs (DC-coefficient) among all of the coefficients for block k.

At step 610, a loop is initiated in which steps 612 and 614 are repeated for each bit-plane b, for block k.

At step 612, each bit-plane of block k is processed, i.e. run-length and VLC coded.

At step 614, each bitplane-block of block k is stored at a respectively different location, starting at a known position. For example, if the current block k is not the first block, the coded bit-plane b portion for block k is appended after the already coded bit-planes b of the previous block k-1 (not shown). Thus, each b^{th} bit-plane of the i^{th} DCT block is stored in a location immediately following the location of the b^{th} bit-plane of the i-1^{th} DCT block, where b is an integer, and i is an integer greater than one. After steps 612-614 are repeated for each bit-plane b, steps 602-614 are repeated for each block k. Thus, the data from the plurality of bit-planes are arranged in the compressed bitstream beginning with the bit-plane corresponding to the maximum one of the maximum magnitudes.

At step 616, the total number of bit-planes N is set to the maximum value of NMAX(k) among all of the blocks.

At step 618, the compressed bit-stream is created, by appending the various bit-planes in the order of their significance (from MSB to LSB). Preferably, the data for each bit-plane are positioned within the compressed bit-stream at the same positions they had in compressed bit-streams generated by the prior art encoder 300 of FIG. 3. In this manner, a compressed bitstream is formed containing the respective plurality of bit-planes for all of the DCT blocks in the image frame, wherein the data in the compressed bitstream are arranged by bit-plane. This compressed bitstream can then be decoded by any decoder capable of decoding the output from the conventional encoder 300 of FIG. 3.

With the above algorithm, it is not necessary to store the DCT residual signals in memory for later access during the decomposition. Further, consecutive masking operations for the various bit-planes are not necessary.

FIG. 5 shows an exemplary FGS encoder 500 for the base and enhancement layers. FIG. 5 shows one example of a functional architecture for the base layer encoder 502 and the enhancement layer encoder 504. Although FIG. 5 shows the encoding operation based on the DCT transform, other transforms (e.g. wavelet) can also be used.

As shown in FIG. 5, the base layer encoder 502 includes a DCT block 506, a quantization block 508 and an entropy encoder 510 that generates part of the BL stream from the original video. Further, the base encoder 502 also includes the motion estimation block 520 that produces two sets of motion vectors from the original video. one set of motion vectors corresponds to the base-layer pictures, while the other set corresponds to the temporal enhancement frames. A multiplexer (not shown) is included to multiplex the base layer motion vectors with the BL stream.

As shown in FIG. 5, the base layer encoder 502 also includes an inverse quantization block 512, an inverse DCT block 514, motion-compensation block 516 and frame-memory 518.

The EL encoder 504 includes a DCT residual image block 550 for storing the residual images and MC residual images. A residual image is generated by a subtracter 551 that subtracts the output from the input of quantization block 508.

The EL encoder 504 does not require a memory to serve the residual storing function of memory 352 in the prior art EL encoder 304. Further, the EL encoder 504 does not require the masking and scanning block 354 for masking and scanning all FGS bit-planes, as required in the prior art EL encoder 304. Instead, the bit-plane residual data for each bitplane-block are provided directly from the DCT residual image block 550 to the FGS scanning and entropy coding block 553 is also included to code the residual images to produce the FGS enhancement stream.

In the exemplary implementation of the FGS encoder 500, after the DCT-transform 506, the DCT-residual signal for each individual block (e.g., the top left block of the image) is decomposed in several bit-plane blocks (from the msb to the lsb or to a certain pre-determined bit-plane e.g. bp_max) consecutively, one bit-plane after the other, until the bitplane-blocks for every bit plane are scanned, before proceeding to the next block.

Each block is then scanned individually, bit-plane by bit-plane and run-length and VLC coded in block 553 for a compact implementation. For each block, the residual image data for all of the bit-planes are available in binary form for encoding block 553, so there is no need to perform complicated masking operations. Also, the coding block 553 only needs all of the bit-plane data for one block at a time, instead of data for a single bit-plane from every block in the frame. Thus, there is no requirement for a large capacity storage device 352, as required in the prior art for this purpose.

The exemplary method and system for fine granular scalability encoding reduces the memory, memory bandwidth and computational complexity necessary for the implementation of an FGS encoder. Moreover, the link between the base-layer and enhancement-layer encoders becomes more tight, allowing for more efficient implementations of FGS codecs by eliminating unnecessary delays and storage.

The method disclosed herein also can be applied in conjunction with the FSG coding tools—selective enhancement and frequency weighting. For the frequency weighting, a fixed matrix is applied for an entire frame, and thus the shifting can be performed immediately after the DCT transform. For the selective enhancement, the shifting of the bit-planes of a particular macroblock can be performed either immediately before the actual scanning and VLC coding of the bit-planes or at a later stage, after the entire frame was coded. The latter methodology allows for more flexibility and also for interactive selective enhancement, but has the disadvantage of a more complex memory and stream management.

Further, this mechanism can be employed beyond the current FGS structure, in prediction frameworks like MC-FGS (Motion-Compensation Fine Granular Scalability) and P-FGS (Progressive Fine Granular Scalability). Different processing is used for PFGS & MCFGS, but the texture coding (i.e., FGS scan & Entropy coding) is the same. So the same technique described above could also be used for MC-FGS and PFGS.

Although the exemplary encoder 500 uses a DCT transform, the method can be employed for other transforms as well, e.g. block-based wavelet coding or matching pursuit and even alternative SNR-scalabilities (using discrete quantization steps rather then bit-planes).

The present invention may be embodied in the form of computer-implemented processes and apparatus for practicing those processes. The present invention may also be embodied in the form of computer program code embodied in tangible media, such as floppy diskettes, read only memories (ROMs), CD-ROMs, hard drives, high density (e.g., “ZIP™”) removable disk drives, or any other computer-readable storage medium, wherein, when the computer program code is loaded into and executed by a computer, the computer becomes an apparatus for practicing the invention. The present invention may also be embodied in the form of computer program code, for example, whether stored in a storage medium, loaded into and/or executed by a computer, or transmitted over some transmission medium, such as over the electrical wiring or cabling, through fiber optics, or via electromagnetic radiation, wherein, when the computer program code is loaded into and executed by a computer, the computer becomes an apparatus for practicing the invention. When implemented on a general-purpose processor, the computer program code segments configure the processor to create specific logic circuits.

Although the invention has been described in terms of exemplary embodiments, it is not limited thereto. Rather, the appended claim should be construed broadly, to include other variants and embodiments of the invention, which may be made by those skilled in the art without departing from the scope and range of equivalents of the invention.

What is claimed is:

1. A method for fine granular scalability encoding, comprising the steps of:
(a) repeating, for each individual transform block in an image frame, the steps of:
(i) decomposing a respective plurality of residual coefficients for the respective transform block;
(ii) processing a respective plurality of bit-planes or discrete quantization steps for the respective transform block before decomposing coefficients for a next one of the transform blocks in the image frame.

2. The method of claim 1, wherein the transform blocks are discrete cosine transform (DCT) blocks, and the residual coefficients are DCT residual coefficients.

3. The method of claim 2, wherein step (ii) includes run-length and variable length coding each of the plurality of bit-planes.

4. The method of claim 2, wherein step (a) further comprises (iii) storing each bit-plane at a respectively different position.

5. The method of claim 4, wherein each b^{th} bit-plane of the i^{th} one of the DCT blocks is stored in a location immediately following the location of the b^{th} bit-plane of the i-1^{th} one of the DCT blocks, where b is an integer, and i is an integer greater than one.

6. The method of claim 2, further comprising:
(b) forming a compressed bitstream containing the respective plurality of bit-planes for all of the DCT blocks in the image frame, wherein the data in the compressed bitstream are arranged by bit-plane.

7. The method of claim 6, wherein:
step (a) further comprises determining a maximum magnitude of any DCT coefficient for the respective DCT block;
the method further comprises determining a maximum one of the maximum magnitudes before step (b); and
the data from the plurality of bit-planes are arranged in the compressed bitstream beginning with the bit-plane corresponding to the maximum one of the maximum magnitudes.

8. The method of claim 6, wherein steps (a) and (b) are performed without requiring simultaneous storage of all the DCT residual coefficients for the image frame.

9. The method of claim 1, wherein the plurality of bit-planes includes each bit-plane from a most significant bit-plane to a least signficant bit-plane.

10. The method of claim 1, wherein the transform blocks are formed by one of the group consisting of discrete cosine transform, block-based wavelet coding or matching pursuit and SNR-scalabilities using discrete quantization steps.

11. Apparatus for fine granular scalability encoding, comprising
means for decomposing a plurality of residual coefficients for an individual transform block of/an image frame;
scanning and coding means for processing a respective plurality of bit-planes or discrete quantization steps for the respective transform block before decomposing coefficients for a next one of the transform blocks in the image frame.

12. The apparatus of claim 11, wherein the scanning and coding means include means for scanning blocks in a first sequence and for storing coded data in a second sequence different from the first sequence.

13. The apparatus of claim 12, wherein:
the transform blocks are discrete cosine transform (DCT) blocks, and the residual coefficients are DCT residual coefficients; and
each b^{th} bit-plane of the i^{th} one of the DCT blocks is stored in a location immediately following the location of the b^{th} bit-plane of the i-1^{th} one of the DCT blocks, where b is an integer, and i is an integer greater than one.

14. The apparatus of claim 11, wherein the apparatus does not have a memory used for simultaneous storage of all the DCT residual coefficients for the image frame.

15. The apparatus of claim 11, wherein the decomposing means provides residual coefficient data for a block directly to the scanning and coding means without storing the residual coefficient data in an intermediate storage device.

16. The apparatus of claim 11, wherein the decomposing means provides residual coefficient data for a block directly to the scanning and coding means without masking the residual coefficient data to extract data for a single bit-plane from all of the blocks in the image frame.

17. A computer readable medium having computer program code encoded thereon, wherein, when the computer program code is executed by a processor, the processor executes a method for fine granular scalability encoding, comprising the steps of:
(a) repeating, for each individual transform block in an image frame, the steps of:
(i) decomposing a respective plurality of residual coefficients for the respective transform block;
(ii) processing a respective plurality of bit-planes or discrete quantization steps for the respective transform block before decomposing coefficients for a next one of the transform blocks in the image frame.

18. The computer readable medium of claim 17, wherein the transform blocks are discrete cosine transform (DCT) blocks, and the residual coefficients are DCT residual coefficients.

19. The computer readable medium of claim 18, wherein step (ii) includes run-length and variable length coding each of the plurality of bit-planes.

20. The computer readable medium of claim 18, wherein
step (a) further comprises storing each bit-plane at a respectively different position; and
each b^{th} bit-plane of the i^{th} one of the DCT blocks is stored in a location immediately following the location of the b^{th} bit-plane of the i-1^{th} one of the DCT blocks, where b is an integer, and i is an integer greater than one.
